(19) United States
(12) Patent Application Publication
(10) Pub. No.: US 2003/0012475 A1
(43) Pub. Date: Jan. 16, 2003

(54) Fixing a wheel hub bearing to the suspension of a motor vehicle

(75) Inventors: Angelo Vignotto, Torino (IT); Mauro Picca, Perosa Argentina (IT)

Correspondence Address: MERCHANT & GOULD PC, P.O. BOX 2903, MINNEAPOLIS, MN, 55402-0903, US

(73) Assignee: SFK INDUSTRIE S.p.A., Torino (IT)

(21) Appl. No.: 10/167,936

(22) Filed: Jun. 10, 2002

(30) Foreign Application Priority Data
Jun. 12, 2001 (IT) TO2001A000562

(51) Int. Cl. F16C 43/00

(52) U.S. Cl. 384/544; 384/537

(57) ABSTRACT

A bearing and suspension standard assembly for a wheel of a motor vehicle comprises a standard (10) with a cylindrical seat (11) in which there is formed at least one circumferential groove (111, 112), and a bearing (12) with a stationary outer race (13) mounted in the seat (11). The outer surface of the outer race (13) has at least a cylindrical side portion of smaller diameter (133) joined to a greater diameter portion (131) by means of an inclined surface (137) facing an inclined or concave portion (117) of the groove (111, 112). An annular fastening element (21) is inserted between the smaller diameter side portion (133) and the seat (11). The annular element (21) has an end portion (213) forcedly inserted between the inclined surface (137) of the bearing and the inclined or concave facing portion (117) of the groove (111, 112) so as to oppose relative movements between the bearing and the standard in at least one axial direction.

The present invention refers to the fixing of a wheel hub bearing into a suspension standard of a motor vehicle.

### BACKGROUND OF THE INVENTION

There are known different methods of assembling the outer race of a hub bearing into a suspension standard. In accordance with a conventional method, the outer race of the bearing is made integral to the standard by forced insertion in a seat of the standard, and the axial locking of the bearing is guaranteed by a shoulder at the outboard side and a retaining ring at the inboard side, or by two retaining rings, one on each side of the outer race of the bearing.

This technique involves a draw back in that the axial locking by means of the retaining ring or rings leaves a residual play between the bearing and its side retaining members, allowing relative axial movement between the bearing and the standard in operational conditions and under the action of axial loads.

To render the axial and circumferential locking of the outer race with respect to the standard more stable, a high radial interference is provided between the bearing outer race and the seat of the standard in which the outer race is housed. To achieve said radial interference, the cylindrical seat of the standard has to be machined accurately. However, in those cases where the standard is made of aluminium or alloys thereof, the locking effects given by the radial interference must not be relied upon, as owing to the difference of thermal expansion coefficients of aluminium and steel, interference fails at the interface between the bearing and the standard when normal operational temperature is reached (about 70° C.).

Therefore, in the absence of efficient locking, the outer race of the bearing tends with time to move both axially and in the circumferential direction, increasing the level of noise and reducing the useful lifetime of the bearing. U.S. Pat. No. 5,782,566 discloses a bearing and suspension standard assembly wherein the outer race of the bearing has a shoulder on one side and, at the other side, a tubular end portion protruding from a seat of the standard in which the bearing is fitted. The tubular portion protruding beyond the standard is cold deformed by rolling in a radially outer direction against a side surface of the standard, so as to lock the bearing to the standard.

In order that the rolling operation is efficient, the tubular end portion must not be hardened. Therefore, the outer race may not be hardened as a whole, but has to be induction hardened in the zone of the raceways only.

### SUMMARY OF THE INVENTION

The object of the present invention is to lock in a simple a reliable manner a bearing in the standard of a suspension, particularly a standard of aluminium or aluminium alloys, obviating the drawbacks of the above discussed prior art, and simplifying the shape of the standard and the bearing outer race. Further, it is desired to make use of bearings made starting from a standard ring of the so-called I generation, preferably hardened as a whole. The invention has the further object of reducing the machining operations to be carried out on elements that are to be coupled together, simplified assembling operations, cutting down assembling time and production costs.

According to a first aspect of the present invention, there is provided a bearing and a standard assembly as defined in claims 1 to 3. According to another aspect of the invention, there is provided a bearing as defined in claims 8 and 9. According to a further aspect of the invention, there is provided an assembling method as defined in claims 10 to 12.

### BRIEF DESCRIPTION OF THE DRAWINGS

The invention is described in the following referring to a few embodiments thereof, shown by way of non-limiting examples, reference being made to the attached drawings, in which:

FIG. 1 is a partial axial sectional view of a bearing fitted in a seat of a suspension standard of a motor vehicle, in a first step of an assembling method according to the invention;

FIG. 2 is an axial sectional view of the bearing and standard assembly of FIG. 1 in an assembled condition;

FIG. 3 is an axial sectional view of an alternative embodiment of a bearing and standard assembly according to the invention; and

FIG. 4 is an axial sectional view of a further alternative embodiment of a bearing and standard assembly in accordance with the invention.

### DESCRIPTION OF THE PREFERRED EMBODIMENTS

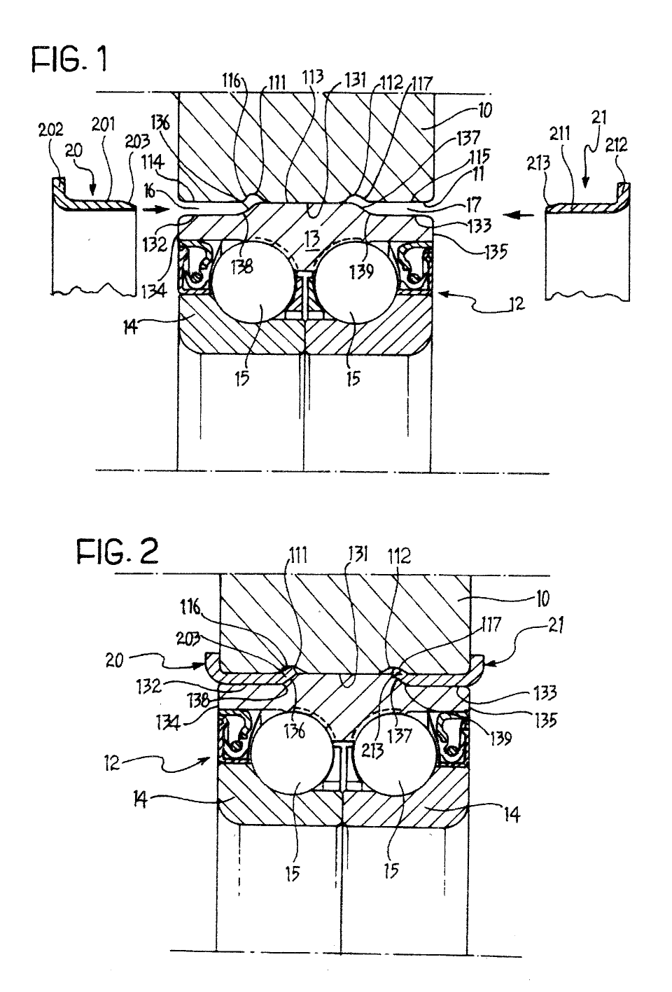

Referring initially to FIG. 1, a suspension standard for the wheel of motor vehicle is designated 10. As mentioned in the introductory part of the description, the standard may be of aluminium or aluminium alloys; however, reference to this possible field of use should not be interpreted as in any way limiting of the scope of the patent.

Formed in the standard 10 is an essentially cylindrical axial seat 11 for receiving a bearing designated overall 12. The bearing 12 includes a radially outer stationary race 13, a radially inner rotatable race 14, in this example consisting of a pair of half-races located side to side, and one or more rolling bodies 15 interposed between the outer race 13 and the inner race 14.

The bearing outer race 13 is advantageously a member hardened as a whole.

The outer surface of the outer race 13 has a central cylindrical portion 131 machined with accuracy and coupled with radial interference with the central cylindrical portion 113 of the seat 11. The outer surface of outer race 13 further has two cylindrical side portions 132, 133 extending from the side faces 134 and 135 of race 13 and having a smaller outer diameter with respect to that of the central portion 131. The side cylindrical portions 132, 133 are not necessarily machined with high accuracy.

The smaller diameter portions 132 and 133 are joined to the central portion of greater diameter 131 by means of respective inclined joining surfaces 136, 137.

As shown in FIG. 1, each cylindrical portion of smaller diameter 132, 133 is joined to its respective inclined joining surface 136, 137 through curved radiused zones 138, 139 the concavities of which are facing radially and axially outer directions.

A pair of circumferential grooves 111, 112 are formed in the cylindrical seat 11 near the inclined joining surfaces 136 and 137 of the race 13. The grooves 111, 112 delimit a central cylindrical zone 113. The portions of the cylindrical seat 11 herein defined “side” portions are designated 114, 115, respectively, and define two cylindrical gaps 16, 17 with the surfaces 132 and 133 of the outer race 13.

The surface portions of grooves 111, 112 designated 116 and 117 facing the inclined joining surfaces 136, 137 of the bearing outer race 13 are adapted to cooperate therewith through a pair of fastening annular elements 20, 21 forcedly inserted into the gaps 16 and 17 as will be better described herein after.

The annular elements 20 and 21 are preferably formed by stamping a flat strip of sheet metal and each have a cylindrical portion 201, 211 and a flange 202, 212 bent in a radially outer direction. The free ends of the cylindrical portions 201, 211 are preferably bevelled at 203, 213 to facilitate their deformation upon insertion between the standard and the bearing outer race.

As indicated by the arrows in FIG. 1, the annular elements 20 and 21 are inserted axially into the gaps 16 and 17 and driven deep into said gaps. The tapered and bevelled end portions 203, 213, upon coming in contact with the curved radiused zones 138, 139 are deflected in essentially radially outwards directions and so guided into the grooves 111, 112.

While the radial size of the gaps 16 and 17 might be slightly greater than the radial thickness of the cylindrical portions 201 and 211 of annular elements 20 and 21, the distance between the pairs of facing surfaces 116 and 136, and 117 and 137 is preferably less then the thickness of the sheet metal of the annular elements 20 and 21, so that the forced insertion of these elements forces their ends to wedge between the standard and the bearing and plastically deform as shown in FIG. 2.

The bearing is so steadily locked in the standard. Owing to the particular arrangement of grooves 111, 112 and inclined surfaces 116, 117, the locking action is efficient both in the axial and radial directions.

In the axial direction, the coupling of the bearing and the standard allows no play and further provides for some amount of axial preload to be kept in time, which favours the stability of the coupling. The stability is guaranteed by the fact that the end portions of the annular elements 20 and 21 are wedged and pressed between the bearing and the standard so as to clamp the central part of the outer race 13. By observing FIG. 2 it will be understood that with a high external load tending to shift the bearing with respect to the standard, the part which opposes axial movements is the end 203 or 213 of one of the annular elements 20 and 21. This part, which undergoes compressive stress, takes the external stress far better as compared to a part which has to resist to tensile or bending stress, as for example the rolled edge indicated with reference numeral 20 in the cited U.S. Pat. No. 5,782,566.

In addition, the forced insertion of the ends 203 and 213 between the bearing and the standard gives also rise to a locking action in the radial and circumferential directions. This contributes to compensate radial interference which occurs at high operational temperatures if the standard is made of aluminium or in any case of an alloy having a thermal expansion coefficient greater than that of the steel of the bearing.

It will be appreciated that owing to the present invention, it is possible to exploit a bearing derived directly from standard bearings of the I generation, which needs only to be machined, with no particular precision, in the side zones of its outer surface to form the surfaces of smaller diameter 132, 133 and the joining surfaces 136, 138 and 137, 139. Further, the outer race of the bearing might advantageously be hardened as a whole instead of being induction hardened in the zones of the raceways only, as is the case of the cited U.S. patent.

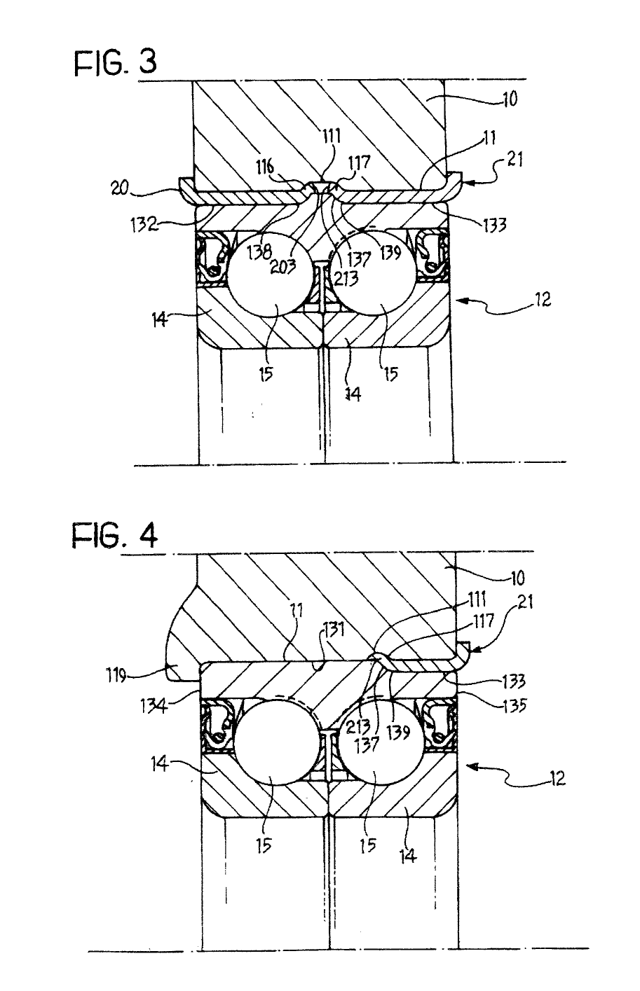

In FIG. 3 there is shown an alternative embodiment of the invention in which a single groove 111 is formed in an essentially central position in the cylindrical seat 11 of the standard 10. The annular elements 20 and 21 have, in this case, a greater axial length with respect to the embodiment of FIGS. 1 and 2 for reaching the central groove 111. Accordingly, the smaller diameter surfaces 132 and 133 of the outer race 13 have a greater axial extension, so that the joining surfaces 136 and 137 face the inclined surface portions 116 and 117 of the groove 111.

Also in the example of FIG. 3 the annular elements 20 and 21 are axially driven deep into the gaps 16 and 17. The ends 203, 213, upon coming into contact with the curved radiused zones 138, 139 are deflected in essentially radially outward directions, guided into the single groove 111 and remain locked between the pairs of facing surfaces 116, 136, 117 and 137.

In FIG. 4 there is shown another alternative embodiment of the invention according to which a single groove 111 is formed in the cylindrical seat 11 of the standard 10 near the inboard inside of the standard. At the outboard side, the seat 11 is delimited by a conventional radial shoulder 119 for abutting the side face 134 of the bearing outer race 13. At the inboard side, the race 13 has a cylindrical surface 113 of smaller diameter which is radiused to the greater diameter portion 131 by means of an inclined joining surface 137 and a curved radiused zone 139, similarly to what is shown in the right parts of FIGS. 1 and 2.

Once the race 13 has been fitted into the seat 11 with its face 134 abutting against the outer shoulder 119, a single annular element 21 is inserted axially and driven deep into the gap 17. The end portion 213, upon coming into contact with the curved radiused zone 139, is deflected in an essentially radially outward direction, guided into the groove 111 and remains locked between the facing surfaces 117 and 137 of the standard 11 and the race 13, respectively.

While different embodiments have been described and shown, it is to be understood that such disclosures are to be considered as examples of fixing the bearing to the standard. The invention might be modified as to shape and location of parts, and constructional and functional details. For example, the shoulder indicated 119 in FIG. 4 might be formed on the inboard side instead of the outboard side. Furthermore, although the annular fastening elements 20 and 21 have been shown provided with flanges 202 and 212, which serve mainly to facilitate gripping of said elements and their forced insertion as described, in still different embodiments of the present invention the annular elements might have a simple cylindrical shape with no flanges.

What is claimed is:

1. A bearing and suspension standard assembly for a wheel of a motor vehicle, comprising:
a standard with a cylindrical seat in which there is formed at least one circumferential groove;
a bearing with a stationary outer race mounted in the seat, wherein the outer surface of the outer race has at least a cylindrical side portion of smaller diameter joined to a greater diameter portion by means of an inclined surface facing an inclined or concave portion of the groove;
at least one annular fastening element inserted between the smaller diameter side portion and the seat, wherein the annular element has an end portion forcedly inserted between the inclined surface of the bearing and the inclined or concave facing portion of the groove so as to oppose relative movements between the bearing and the standard in at least one axial direction.

2. An assembly according to claim 1, comprising:
a standard with a cylindrical seat and a circumferential groove formed therein;
a bearing with a stationary outer race mounted in the seat, wherein the outer surface of the outer race has two cylindrical side portions of smaller diameter joined to a central portion of greater diameter by means of two respective inclined surfaces each facing a respective inclined or concave portion of the groove, wherein the facing surfaces have an opposite inclination to that of the facing surfaces;
two annular fastening elements each fitted between one of the side portions of smaller diameter and the seat, wherein the annular elements have end portions forcedly fitted between the respective inclined surfaces of the bearing and the inclined or concave facing portions of the grooves so as to oppose relative axial movements between the bearing and the standard.

3. An assembly according to claim 1, comprising:
a standard with a cylindrical seat in which there are formed first and second axially spaced circumferential grooves;
a bearing with a stationary outer race mounted in the seat, wherein the outer surface of the outer race has two cylindrical side portions of smaller diameter respectively joined to a central portion of greater diameter by means of a first inclined surface and a second inclined surface having an inclination opposite to that of the first inclined surface, each inclined surface facing a respective inclined or concave surface of the grooves;
a first annular fastening element fitted between one of the cylindrical side portions of smaller diameter and the seat, and a second annular fastening element fitted between the other cylindrical side portion of smaller diameter and the seat, wherein the first annular element has an end portion forcedly fitted between the first inclined surface of the bearing and the facing inclined or concave portion (116) of the first groove, and wherein the second annular element has an end portion forcedly fitted between the second inlined surface of the bearing and the facing inclined or concave portion of the second groove, so as to oppose relative axial movement between the bearing and the standard.

4. An assembly according to any one of claims 1 to 3, wherein each cylindrical surface of smaller diameter is joined to the respective inclined surface by means of a respective curved and concave radiused zone.

5. An assembly according to any one of claims 1 to 4, wherein the end portions of the annular fastening elements are tapered or beveled.

6. An assembly according to any one of claims 1 to 4, wherein the annular element or elements is formed by stamping from a flat strip of sheet metal.

7. An assembly according to any one of claims 1 to 4, wherein the annular element or elements each have a flange bent in a radially outer direction.

8. A motor vehicle wheel hub bearing for an assembly according to claim 1, the bearing having a stationary outer race for mounting in a cylindrical seat of a suspension standard of a motor vehicle, wherein the outer surface of the outer race has at least one cylindrical side portion of smaller diameter joined to a portion of greater diameter by means of an inclined surface adapted to face an inclined or concave portion of a groove formed in the seat.

9. A motor vehicle wheel hub bearing for an assembly according to claim 2 or 3, the bearing having an outer stationary race for mounting into a cylindrical seat of a motor vehicle suspension standard, wherein the outer surface of the outer race has two cylindrical side portions of smaller diameter joined to a central portion of greater diameter by means of two respective inclined surfaces having opposite inclinations and each adapted to face a respective inclined or concave portion of at least one groove formed in the seat of the suspension.

10. A method of assembling a bearing and suspension standard assembly for a motor vehicle wheel, comprising the steps of:
providing a standard with a cylindrical seat having at least one circumferential groove;
providing a bearing with an outer race the outer surface of which has at least one cylindrical side portion of smaller diameter joined to a portion of greater diameter by means of an inclined surface;
fitting the bearing into the seat, facing the inclined surface to an inclined or concave portion of the groove;
inserting at least one annular fastening element between the side portion of smaller diameter and the seat, so that the annular element has an end portion forcedly fitted between the inclined surface of the bearing and the inclined or concave facing portion of the groove so as to oppose relative movement between the bearing and the standard in at least one axial direction.

11. A method of assembling a bearing and suspension standard assembly for the wheel of a motor vehicle, comprising the steps of:
providing a standard with a cylindrical seat with a circumferential groove formed therein;
providing a bearing with an outer stationary race the outer surface of which has two cylindrical side portions of smaller diameter joined to a central portion of greater diameter by means of two respective inclined surfaces with opposite inclinations;
fitting the bearing into the seat facing the inclined surfaces to a respective inclined or concave portion of the groove;
providing first and second annular fastening elements;
inserting the first annular fastening element between one of the cylindrical side portions of smaller diameter and the seat and inserting the second annular fastening element between the other cylindrical side surface of smaller diameter and the seat, so that the first annular element has an end portion forcedly fitted between the first inclined surface of the bearing and the inclined or concave facing portion of the groove, and the second annular element has an end portion forcedly inserted between the second inclined surface of the bearing and the inclined or concave facing portion of the groove, so as to oppose relative axial movements between the bearing and the standard.

12. A method of assembling a bearing and suspension standard assembly for a motor vehicle wheel, comprising the steps of:
providing a standard with a cylindrical seat in which there are formed first and second axially spaced circumferential grooves;
providing a bearing with an outer race the outer surface of which has two cylindrical side portions of smaller diameter respectively joined to a central portion of greater diameter by means of a first inclined surface and a second inclined surface the inclination of which is opposite to that of the first inclined surface;
fitting the bearing into the seat, facing each inclined surface to a respective inclined or concave portion of the grooves;
providing first and second annular fastening elements;
inserting the first annular element between one of the cylindrical side portions of smaller diameter and the seat and inserting the second annular fastening element between the other cylindrical side portion of smaller diameter and the seat, so that the first annular element has an end portion forcedly fitted between the first inclined surface of the bearing and the inclined or concave facing portion of the first groove, and the second annular element has an end portion forcedly fitted between the second inclined surface of the bearing and the inclined or concave facing portion of the second groove, so as to oppose axial relative movements between the bearing and the standard.
